(19) United States
(12) Patent Application Publication
(10) Pub. No.: US 2010/0058413 A1
(43) Pub. Date: Mar. 4, 2010

(54) APPARATUS AND METHOD FOR PROVIDING AUDIO AND/OR VIDEO DATA FOR IPTV

(75) Inventor: Heiko Emser, Ober-Ramstadt (DE)

Correspondence Address: DARBY & DARBY P.C., P.O. BOX 770, Church Street Station, New York, NY, 10008-0770, US

(73) Assignee: Deutsche Telekom AG, Bonn (DE)

(21) Appl. No.: 12/551,786

(22) Filed: Sep. 1, 2009

(30) Foreign Application Priority Data
Sep. 3, 2008 (EP) 08105214

(51) Int. Cl. H04N 7/173

(52) U.S. Cl. 725/109

(57) ABSTRACT

A method for providing audio and/or video data for Internet Protocol Television includes receiving source material. Encoded source data is generated by encoding the source material in a target format. The encoded source data is transmitted to a memory that is configured to output the encoded source data.

### CROSS REFERENCE TO RELATED APPLICATIONS

Priority is claimed to European Patent Application No. EP 08105214, filed Sep. 3, 2008, which is hereby incorporated by reference herein.

### FIELD

The invention relates to an apparatus and a method for providing or preparing audio and/or video data for output to an Internet Protocol Television (IPTV) network.

### BACKGROUND

In prior art systems, as shown schematically in FIG. 1, audio and/or video data with high signal quality, hereinafter also called source material, is provided for post-production from a source material memory 2. Such a source material memory 2 may be a fixed-disk memory or a magnetic recording tape, for example. In post-production, the A/V source material can be edited or processed in order to alter certain parameters, such as the color, for example. High-quality signals are used in post-production, for example an uncompressed digital serial component signal DSC with a sampling interval of 4:4:4 (R:G:B or Y:C_{B}:C_{R}) or 4:4:2. The A/V data are stored in a production server 4 for post-production. A production server 4 is a server with large storage capacity that can make video and audio material available for shared use by several nonlinear editing stations.

After post-production, the A/V data can be stored in an archive server 6 or can be sent directly to a transmission server 10. The data are often compressed to a certain extent after post-production, for example by means of the MPEG-2 method, to be able to use memory space more efficiently. Since the development of video data formats is unpredictable, formats that store every frame instead of working with a long group of pictures GOP are preferred, which is why higher data compression is not performed. The video signals stored in the archive server 6 can also be stored uncompressed, for example in the *.avi format.

A transmission system 8 transmits the data from the archive server 6, or directly from the production server 4, to a transmission server 10 when needed. A transmission server 10 supplies A/V data for broadcast, i.e. transmission to the end user, via broadcast, multicast, or singlecast methods. In particular, the A/V data can be provided for an IPTV infrastructure 14 by the transmission server 10. To this end, the signals stored in the transmission server 10 can be output through a serial digital video interface SDI and be delivered to hardware encoders in order to code the signals in a different format such as H.264 (MPEG4). One encoder 12₁, 12₂, . . . , 12ₙ is required for each transmission channel 1, 2, . . . , n.

In the prior art systems, problems result from the enormous amounts of memory space required by the video signals, as well as from the fact that these signals have to be transmitted between the production site and the playback location, i.e. the location of the transmission server 10 and the subsequent IPTV components.

### SUMMARY

In an embodiment, the present invention provides a method for providing audio and/or video data for Internet Protocol Television. The method includes receiving source material. Encoded source data is generated by encoding the source material in a target format. The encoded source data is transmitted to a memory that is configured to output the stored, encoded source data.

### BRIEF DESCRIPTION OF THE DRAWINGS

Illustrative, non-limiting embodiments of the present invention are described by way of example with reference to the attached drawings, in which the same reference numbers are used to designate the same or similar components in different figures, in which:

FIG. 1 is a block diagram of a prior art system; and

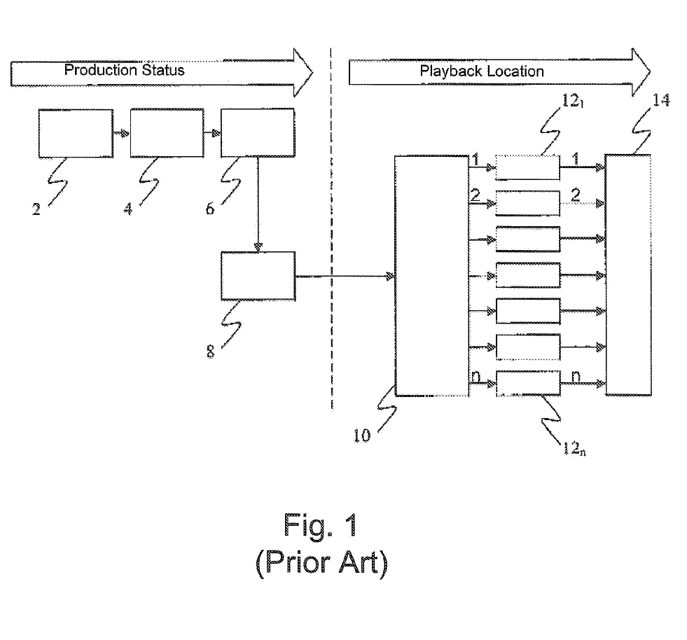

FIG. 2 is a block diagram of an embodiment of the present-invention.

### DETAILED DESCRIPTION

An aspect of the present invention is to provide an apparatus and a method with which faster and more economical data processing of A/V data up to the point of output to an IPTV network is achieved, in particular for the output of repetitive content such as loops.

One aspect of the invention is based on early coding of the A/V data in the target format in order to minimize processing effort in the subsequent steps, in particular the storage and transmission of the data from the production site to the playback location. To this end, according to one aspect of the present invention, the audio/video source material is compressed, if this has not already occurred, for example using MPEG2 or MPEG4, and encoded. After encoding, the A/V data can be recorded, for example in the form of a transport stream. After optional processing of the transport streams, the data are transmitted, preferably as a transport stream, to a playback location, for example a transmission server. The transmission server makes the A/V data available for output to an IPTV network.

As a result of the use of the inventive method or the inventive apparatus, significantly less hardware is required for storage and transmission of the A/V data. Furthermore, fewer encoders are needed, since these are preferably only used at the production site.

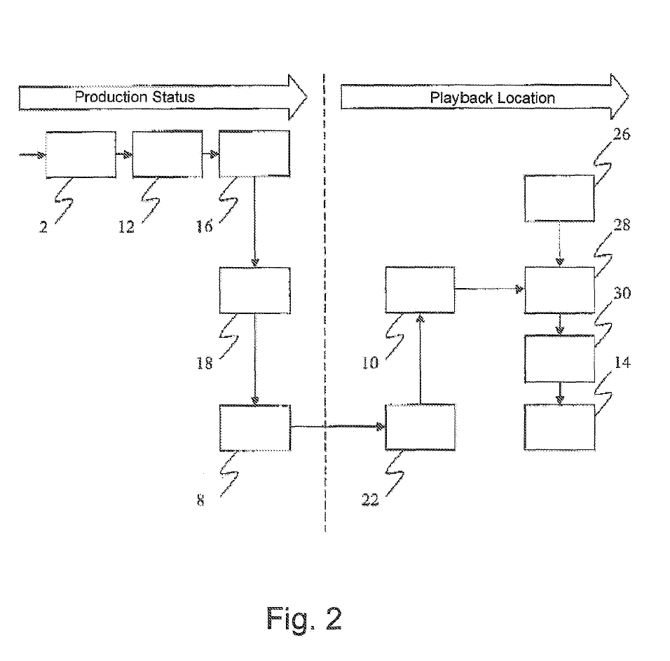

FIG. 2 shows an embodiment of the inventive system. Fully produced source material, for example a finished clip, segment, or feature film, is played back from a source material memory 2, for example a fixed disk memory or a magnetic tape, to an encoder 12. The source material memory 2 can transmit the A/V data to the at least one encoder 12 through an analog or digital interface such as SDI-HD or SDI. Two or more encoders 12 may also be used. The coding of the A/V data in the desired target format takes place in the encoder 12. The desired target format and its parameters depend on the boundary conditions and quality requirements of the distributors of the A/V data, i.e. live IPTV transmitters. Examples of a target format are MPEG2, MPEG4, or JPEG2000.

The signal provided by the encoder 12 can be transmitted through an IP or ASI output of the encoder 12 as a transport stream to a suitable recording device 16 for recording. This recording can be carried out by a PC/server, for example. Preferably, the transport stream that is present is processed on this PC/server in a processing device 18 with appropriate software. In this processing, individual frames of the transport stream may be removed at the beginning and/or the end of the clip/segment/feature film. The transport stream preferably begins with an intracoded I-frame and ends with the last frame before an I-frame, so that a loop is produced in which this clip or segment can be repeated without difficulty. This type of processing does not require high-quality signals as postproduction does. The A/V data can optionally be stored in an archive server. In accordance with an embodiment of the invention, recoding of the A/V data no longer takes place, which means that all settings such as bit rates, tables, and GoP structures remain unchanged.

The A/V data are preferably transmitted from the production site to a data server 22 at a playback location as a transport stream by means of a transmission system 8. This data transmission can take place through an IP connection using appropriate transmission protocols, as for example FTP. Furthermore, secured data transmission via IPsec or a tunneling solution is possible, for which reason additional servers may be present in the transmission path. Alternatively, the data transmission can also take place by means of removable disks if there is no fixed connection to the target system or if an existing fixed connection is inadequate with regard to the quantity of data to be transferred.

The transport streams are stored in a data system on the target system, which preferably has a transmission server 10. The target system can be a PC/server and can have two or more IP interfaces. One interface is used to configure and control the target system. A second interface can be connected directly to a multiplexer 28, or alternatively to an output switch, in order to provide the A/V data to subsequent IPTV components. The transport streams can be fed directly into the IPTV network through this second interface, for example as multicast transport streams in an endless loop. Multiple channels are preferably available here depending on the performance of the system and interfaces. The transmission of the A/V data from the multiplexer to the receiver can be transmitted via IPTV middleware 30 in the IPTV infrastructure. The IPTV middleware 30 controls the transmission of the data over the IPTV network.

According to one aspect of the invention, the target system has a graphical user interface (GUI) that is able to select the individual transport streams from the data systems and assign them to multicast addresses. Further options include a time-controlled reproduction or the management of reproduction lists through an integrated database, and depend on the level of detail of the control software that controls the transmission server.

As is shown in FIG. 2, suitable data, as for example Service Information (SI) data, which are generated by an auxiliary data generator 26, can be appended to the transport stream via the multiplexer 28. Such SI data can have EPG information.

While the invention has been particularly shown and described with reference to preferred embodiments thereof, it will be understood by those skilled in the art that various changes in form and details may be made therein without departing from the spirit and scope of the invention.

What is claimed is:

1. A method for providing audio and/or video data for Internet Protocol Television, the method comprising the following steps:
receiving source material;
generating encoded source data by encoding the source material in a target format; and
transmitting the encoded source data to a memory that is configured to output the encoded source data.

2. The method according to claim 1, wherein the step of generating encoded source data comprises recording the encoded source material in a form of a transport stream.

3. The method according to claim 1, further comprising the step of processing the encoded source data, such that a beginning of a video content is an intracoded image.

4. The method according to claim 1, wherein the encoded source data is transmitted to an intermediate storage.

5. The method according to claim 4, wherein the intermediate storage includes a data server.

6. The method according to claim 1, further comprising the step of outputting the encoded source data by the memory.

7. The method according to claim 6, further comprising the step of multiplexing the encoded source data with auxiliary data so as to produce multiplexed data.

8. The method according to claim 7, wherein the auxiliary data includes service information.

9. The method according to claim 7, wherein the multiplexed data is output through an Internet Protocol Television network to a user.

10. The method according to claim 1, wherein the target format is at least one of MPEG2, MPEG4, and JPEG2000.

11. A system for providing audio and/or video data for Internet Protocol Television, comprising:
a device configured to provide source material;
an encoder configured to generate encoded source data by encoding the source material in a target format; and
a memory configured to store and to output the encoded source data.

12. The system according to claim 11, further comprising a multiplexer configured to generate multiplexed data by multiplexing the stored encoded source data with auxiliary data and to output the multiplexed data through an Internet Protocol Television network to a user.

13. The system according to claim 12, wherein the auxiliary data includes service information.
